(19) United States
(12) Patent Application Publication
(10) Pub. No.: US 2006/0239413 A1
(43) Pub. Date: Oct. 26, 2006

(54) Soft x-ray shielding structure, soft x-ray irradiation static eliminating apparatus, and ionized-air emitting method

(75) Inventors: Kengo Honma, Chino (JP); Hitoshi Nakao, Suwa (JP); Motoki Itoda, Suwa (JP); Osamu Gomi, Suwa (JP); Kazuhiro Suzuki, Nishigou (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/369,924

(22) Filed: Mar. 7, 2006

(30) Foreign Application Priority Data
Mar. 25, 2005 (JP) 2005-090087

(51) Int. Cl. H01J 35/16

(52) U.S. Cl. 378/203

(57) ABSTRACT

There is provided a soft X-ray shielding structure of a soft X-ray irradiation static eliminating apparatus which irradiates air to be supplied with soft X-rays and ionizes the same, the soft X-ray shielding structure allowing the passing of the ionized air and shielding the soft X-rays and including: an accommodation body having a mesh-like inflow opening and a mesh-like outflow opening and made of a soft X-ray shielding material; and a plurality of massive members filled in the accommodation body and made of a substance shielding electromagnetic waves.

The entire disclosure of Japanese Patent Application No. 2005-90087, filed Mar. 25, 2005, is expressly incorporated by reference herein.

### BACKGROUND

1. Technical Field

The present invention relates to a soft X-ray shielding structure, a soft X-ray irradiation static eliminating apparatus, and an ionized-air emitting method, used for eliminating the static of a charged body.

2. Related Art

A known soft X-ray irradiation static eliminating apparatus is of a type including a duct for supplying air, a chamber connected to the duct and having an outlet, a shielding portion provided in the outlet and composed of two punching plates, and a soft X-ray irradiating unit provided in the chamber and irradiating air passing through the chamber with soft X-rays. Reference is made to JP-A-2001-257096 as an example of related art.

The air supplied from the duct is ionized by the soft X-ray irradiating unit in the chamber. In other words, when gaseous molecules are irradiated with soft X-rays, electrons of the gaseous molecules obtain energy and fly out therefrom and the gaseous molecules which have lost the electrons become positive ion-molecules. On the other hand, the emitted electrons collide with gaseous molecules, and the gaseous molecules take the electrons therein and become negative ion-molecules. The air is thus ionized. Thereafter, the ionized air is transferred to a charged body by air flow and the ionized molecules having electrical polarity opposite to that of the charged body are attracted to the charged body, which in turn eliminates static therefrom. In this case, the two punching plates constituting the shielding portion are disposed such that they have a small gap therebetween and punching holes thereof are shifted from one another. Accordingly, the ionized air can pass through the shielding portion, and the soft X-rays irradiated in the chamber are prevented from leaking outside the soft X-ray irradiation static eliminating apparatus.

However, when soft X-rays enter at an incident angle connecting the punching holes of the back-and-forth punching plates under the configuration of the shielding portion, they will leak outside the apparatus, implying that there is a problem of not being able to totally shield electromagnetic waves such as soft X-rays.

### SUMMARY

It is an advantage of the invention to provide a soft X-ray shielding structure, a soft X-ray irradiation static eliminating apparatus, and an ionized-air emitting method, capable of enhancing a shielding property of electromagnetic waves such as soft X-rays without hindering the supplying of ionized air.

According to a first aspect of the invention, there is provided a soft X-ray shielding structure of a soft X-ray irradiation static eliminating apparatus which irradiates air to be supplied with soft X-rays and ionizes the same. The soft X-ray shielding structure allows the passing of the ionized air and shields the soft X-rays and comprises: an accommodation body having a mesh-like inflow opening and a mesh-like outflow opening and made of a soft X-ray shielding material; and a plurality of massive members filled in the accommodation body and made of a substance shielding electromagnetic waves.

According to this configuration, some of electromagnetic waves such as soft X-rays will be reflected, but most of them will hit on the massive members and be absorbed therein when applied to the plurality of massive members. On the other hand, the air ionized by soft X-rays weaves through air space generated between the respective massive members and is supplied outside from the outflow opening when it moves from the inflow opening to the outflow opening. Accordingly, it is possible to smoothly supply ionized air from the outflow opening and totally shield electromagnetic waves such as soft X-rays.

In this case, it is preferable that each of the massive members be formed into a spherical shape.

According to this configuration, even if the plurality of massive members are filled in the accommodation body, enough air space through which ionized air passes can be obtained.

In this case, it is preferable that each of the massive members be made of a substance having high atomic density.

According to this configuration, the mass absorption coefficient of electromagnetic waves is based on atomic density and a distance which electromagnetic waves travel. In other words, the higher the atomic density, the thinner the thickness of the substance shielding electromagnetic waves can be. Accordingly, the use of high atomic density for the massive members makes it possible to enhance the absorption ratio of electromagnetic waves in proportion to the size of the massive members. At the same time, the accommodation body can be reduced in size. Note that examples of substances having high atomic density include boron nitride, silicone carbide, silicone, carbon, fullerene, carbon nano tube, acrylic, acrylonitrile, butadiene-styrene, polyvinyl chloride, or the like.

In this case, it is preferable that each of the massive members be made of polyvinyl chloride.

According to this configuration, it is possible to provide a structure which has high shielding property and is reduced in size. In addition, since polyvinyl chloride is an inexpensive material and easily processable, the manufacturing cost can be suppressed.

According to a second aspect of the invention, there is provided a soft X-ray shielding structure of a soft X-ray irradiation static eliminating apparatus which irradiates air to be supplied with soft X-rays and ionizes the same. The soft X-ray shielding structure allows the passing of the ionized air and shields the soft X-rays and comprises: an accommodation body having an inflow opening and an outflow opening and made of a soft X-ray shielding material; and a plurality of spacers for partitioning an air passage running from the inflow opening to the outflow opening into a plurality of passages and made of a substance shielding electromagnetic waves, wherein the plurality of spacers are disposed parallel to one another and undulately extend from the inflow opening to the outflow opening.

According to this configuration, some of electromagnetic waves such as soft X-rays will be reflected, but most of them will hit on the spacers and be absorbed therein when applied to the plurality of spacers. On the other hand, the air ionized by soft X-rays passes through air space generated between the respective spacers from the inflow opening and is supplied outside from the outflow opening. Accordingly, it is possible to smoothly supply ionized air from the outflow opening and totally shield electromagnetic waves such as soft X-rays.

According to a third aspect of the invention, there is provided a soft X-ray shielding structure of a soft X-ray irradiation static eliminating apparatus which irradiates air to be supplied with soft X-rays and ionizes the same. The soft X-ray shielding structure allows the passing of the ionized air and shields the soft X-rays and comprises: an accommodation body having an inflow opening and an outflow opening and made of a soft X-ray shielding material; and a plurality of column members crossing an air passage running from the inflow opening to the outflow opening and made of a substance shielding electromagnetic waves, wherein the plurality of column members are disposed parallel to one another along the air passage in a staggered manner.

According to this configuration, some of electromagnetic waves such as soft X-rays will be reflected, but most of them will hit on the column members and be absorbed therein when applied to the plurality of column members. On the other hand, the air ionized by soft X-rays passes through air space generated between the respective column members from the inflow opening and is supplied outside from the outflow opening. Accordingly, it is possible to smoothly supply ionized air from the outflow opening and totally shield electromagnetic waves such as soft X-rays.

According to a fifth aspect of the invention, there is provided a soft X-ray irradiation static eliminating apparatus. The soft X-ray irradiation static eliminating apparatus comprises: the soft X-ray shielding structure described above; a housing having an introduction port into which air is introduced and an emission port from which the air is emitted; and a soft X-ray irradiating unit which is provided in the housing and irradiates the air flowing in the housing with X-rays, wherein the emission port is connected directly with the inflow opening.

According to this configuration, since the emission port of the soft X-ray irradiation static eliminating apparatus is connected directly with the inflow opening, soft X-rays and electromagnetic waves are prevented from leaking outside the emission port and the inflow opening of the accommodation body, and ionized air can be supplied from the outflow opening. Furthermore, an apparatus configuration can be reduced in size, thereby enhancing portability and degree of freedom for installation so as to offer convenience to the user.

In this case, it is preferable that a peripheral wall portion of the accommodation body be integrally formed with that of the housing.

According to this configuration, there is provided an apparatus configuration in which the soft X-ray irradiation static eliminating apparatus and the soft X-ray shielding structure are integrally formed. Accordingly, it is possible to simplify the structure and have the apparatus reduced in size.

In this case, it is preferable that the soft X-rays irradiated by the soft X-ray irradiating unit be oriented in the same direction as the flowing direction of the air.

According to this configuration, since soft X-rays are irradiated in the same direction as the flowing direction of air, soft X-rays irradiated by the soft X-ray irradiating unit are oriented toward the emission port. As the soft X-ray irradiating unit is caused to move closer to the emission port, the projected area of irradiation light of soft X-rays is made smaller. Accordingly, it is possible to efficiently ionize air and have the soft X-ray shielding structure reduced in size so as to correspond to the projected area.

In this case, it is preferable that a fan for supplying the air be detachably attached on the side of the introduction port of the housing.

According to this configuration, the apparatus can forcibly send air with the fan and supply ionized air by itself. In other words, the apparatus can serve alone as a static eliminating apparatus. Furthermore, when a duct or the like is used to supply air, it is possible to use the apparatus with the fan removed therefrom. In other words, the apparatus can be selectively used to suit the situations such as a case in which it is used alone or that in which the fan is not required when it is incorporated into an outlet.

In this case, it is preferable that a fan for supplying the air be provided in the housing facing the introduction port.

According to this configuration, the apparatus can be integrally formed by incorporating the fan into the housing. Accordingly, it is possible to simplify the structure and have the apparatus reduced in size.

According to a sixth aspect of the invention, there is provided an ionized-air emitting method of a soft X-ray irradiation static eliminating apparatus which irradiates air to be supplied with soft X-rays and emits the same after being ionized. The ionized-air emitting method comprises having the ionized air passed through the deposition of a plurality of massive members made of a substance shielding electromagnetic waves and emitted therefrom.

According to the configuration, electromagnetic waves resulting from the ionization of soft X-rays and air are prevented from leaking from the outflow opening of the accommodation body, thereby making it possible to smoothly supply ionized air from the outflow opening.

### BRIEF DESCRIPTION OF THE DRAWINGS

The invention will be described with reference to the accompanying drawings, wherein like numbers reference like elements.

FIG. 1 is a schematically-represented structural drawing of a soft X-ray irradiation static eliminating apparatus according to embodiments.

FIGS. 2A and 2B are an external perspective view of a shielding unit according to a first embodiment and a cross-sectional view of the shielding unit taken along line A-A, respectively.

FIGS. 3A and 3B are a graphical representation of the soft X-ray shielding ratio of PVC, PC, and PET and a graphical representation of mass absorption coefficient and the soft X-ray shielding ratio, respectively.

FIG. 4 is a table in which comparative experiments on a static eliminating performance and a leakage amount of soft X-rays are conducted.

FIGS. 5A and 5B are an external perspective view of a shielding unit according to a second embodiment and a cross-sectional view of the shielding unit taken along line C-C, respectively.

FIGS. 6A and 6B are an external perspective view of a shielding unit according to a third embodiment and a cross-sectional view of the shielding unit taken along line C-C, respectively.

FIGS. 7A to 7C are a first example of using the soft X-ray irradiation static eliminating apparatus according to the embodiments, a second example of using thereof, and a third example of using thereof, respectively.

### DESCRIPTION OF EXEMPLARY EMBODIMENTS

Hereinafter, referring to the accompanying drawings, description will be made about a soft X-ray shielding unit and a soft X-ray irradiation static eliminating apparatus to which is applied a soft X-ray shielding structure according to an embodiment of the invention. According to the soft X-ray irradiation static eliminating apparatus, air is taken from the backward side of the apparatus and irradiated with soft X-rays so as to be ionized. The resulting ionized air is supplied forward to a charged body and static is eliminated therefrom.

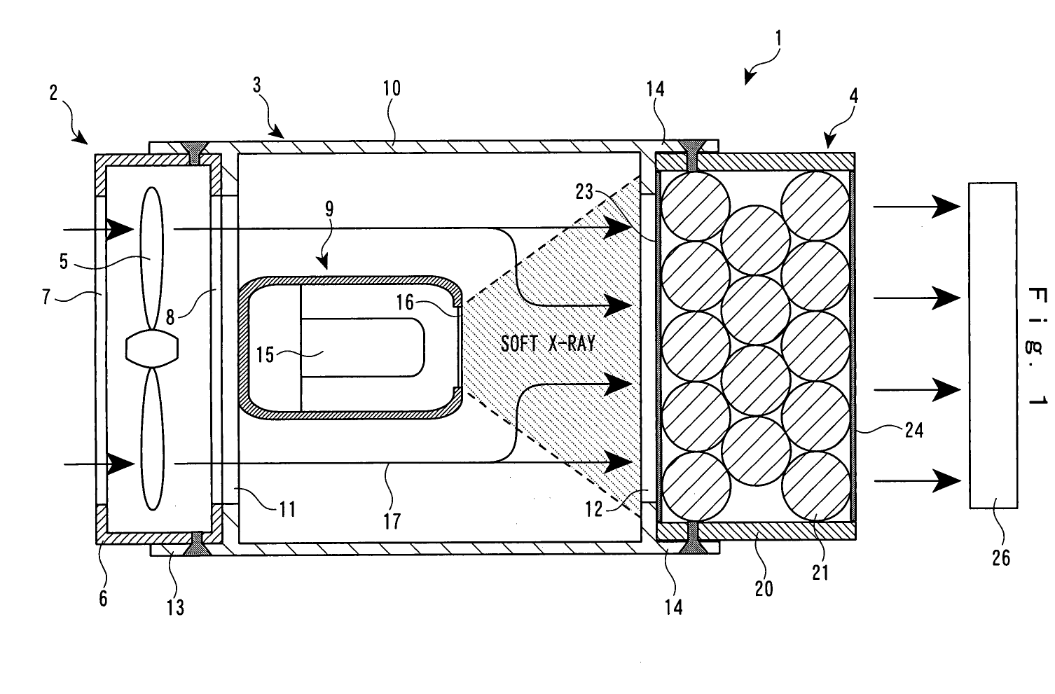

FIG. 1 is a schematically represented structural drawing of the soft X-ray irradiation static eliminating apparatus. As seen in FIG. 1, the soft X-ray irradiation static eliminating apparatus 1 includes a fan unit 2 disposed on the backward side thereof, a soft X-ray irradiating unit 3 disposed in the intermediate part thereof and serving to irradiate the air to be supplied from the fan unit 2 with soft X-rays, and a shielding unit 4 disposed on the forward side thereof and serving to shield the soft X-rays irradiated from the soft X-ray irradiating unit 3.

The fan unit 2 includes an air-supplying fan 5 composed of an axial fan or the like for supplying air forward and a box-shaped fan casing 6 for accommodating the air-supplying fan 5. In the fan casing 6, an air-intaking opening 7 for sucking fresh air (air) and an air-supplying opening 8 for supplying the sucked air to the soft X-ray irradiating unit 3 are provided. The front side of the fan casing 6 is joined with the backward side of the soft X-ray irradiating unit 3 and fastened with screws in this state. In other words, the fan unit 2 is detachably attached to the soft X-ray irradiating unit 3.

The soft X-ray irradiating unit 3 includes a soft X-ray irradiating device 9 from which soft X-rays are irradiated at an angle covering the shielding unit 4 and a housing 10 for accommodating the soft X-ray irradiating device 9. The housing 10 has a box-shaped structure made of polyvinyl chloride or the like as a shielding material and includes an introduction port 11 into which the air supplied from the air-supplying opening is received as it is and an emission port 12 through which air passes and is emitted to the shielding unit 4. Furthermore, the housing 10 is integrally formed with a rear-side joint portion 13 extending backward from the introduction port 11 and a forward-side joint portion 14 extending forward from the emission port 12. The backward-side joint portion 13 is joined with the fan unit 2, and the forward-side joint portion 14 is joined with the shielding unit 4, both of which are fastened with screws in this state. In other words, the soft X-ray irradiating unit 3 is detachably attached with the shielding unit 4 in the same manner as the fan unit 2.

The soft X-ray irradiating device 9 incorporates a soft X-ray tube 15 from which soft X-rays are irradiated and is arranged at the rear center of the housing 10 with an irradiation window facing forward, namely the shielding unit 4.

The soft X-rays irradiated from the soft X-ray tube 15 pass through the irradiation window 16, thereby making its irradiation angle substantially adapted to the size of the emission port 12. While the air which passes through the soft X-ray irradiating unit 3 is irradiated with soft X-rays, it ionizes to positive ions and negative ions with this soft X-ray irradiation. Accordingly, the ionized air is supplied to the shielding unit 4 from the emission port 12. Soft X-rays are irradiated on the whole region of the emission port 12 in this manner, whereby air can be efficiently ionized. Note that, since soft X-rays are irradiated in the same direction as flowing direction 17 of air, the projected area of the soft X-rays is based on the distance between the soft X-ray irradiating device 9 and the emission port 12. That is to say, when the soft X-ray irradiating device 9 commercially available is used, it is necessary that the distance between the soft X-ray irradiating device 9 and the emission port 12 is controlled to make its irradiation angle adapted to the emission port 12.

The ionized air which has passed through the emission port 12 is then supplied to the shielding unit 4. At the same time, soft X-rays also pass through the emission port 12 and enter into the shielding unit 4. As described above, the fan unit 2 and shielding unit 4 are fastened to the front and backward sides of the soft X-ray irradiating unit 3 with screws, respectively. Alternatively, they may be promptly attached or detached with a catch clip or the like. Furthermore, it is preferable that each of the units be shielded so as to prevent air or soft X-rays from entering therein.

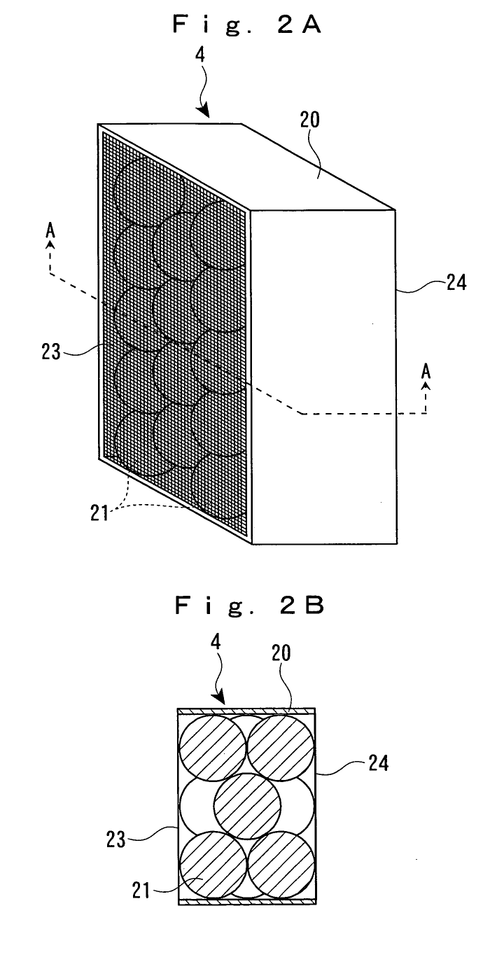

Referring next to FIGS. 2A and 2B, description will be specifically made about the shielding unit 4 according to a first embodiment. The shielding unit 4 includes a shielding material shielding the soft X-rays irradiated from the soft X-ray irradiating unit 3 and an accommodation body 20 having shielding materials filled therein. The shielding materials are composed of a plurality of spherical members 21. The accommodation body 20 has a box-shaped structure made of a material such as polyvinyl chloride having high shielding property and is provided with a mesh-like inflow opening 23 at its rear surface and a mesh-like outflow opening 24 at its front surface (see FIG. 2A). The mesh structure allows the passing of air and holds the plurality of spherical members 21 in the accommodation body 20. Note that a punching material may be substituted for meshes.

Each of the plurality of spherical members 21 is also made of polyvinyl chloride (i.e., vinyl ball) and has a diameter of about 15 mm (see FIG. 2B). As specifically described below, the diameter of the spherical members 21 is large enough for shielding soft X-rays. The plurality of spherical members 21 are filled in such a manner that they do not move in the accommodation body 20 and air spaces generated according to the arrangement of the plurality of spherical members 21 are not aligned. With this structure, the soft X-rays straightly traveling from the inflow opening 23 to the outflow opening 24 necessarily will hit on the plurality of spherical members 21 filled and be absorbed therein. Besides, since the plurality of spherical members 21 are brought into point-contact with one another, air spaces are necessarily generated among them. Accordingly, the ionized air reaches the outflow opening 24 in such a manner as to weave through the air spaces.

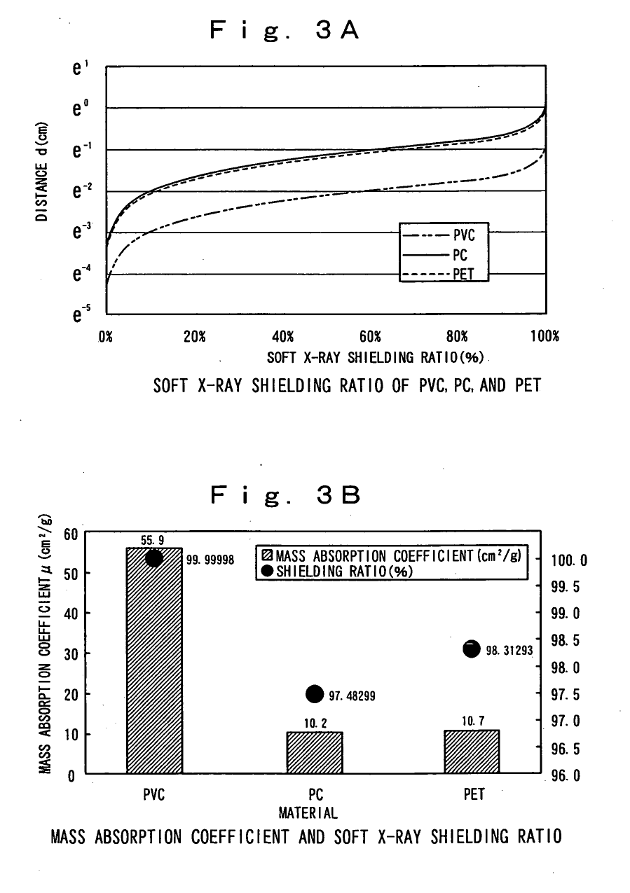

Referring now to FIGS. 3A and 3B and the following equation, description will be made about the effectiveness of polyvinyl chloride used as a shielding material for soft X-rays. The equation μ=−{Logₑ(I/Ia)/ρd} is obtained by transforming an equation wherein as pre-transmitted soft X-rays Ia (μSv/h) travel through obstacles having atomic density ρ(g/cm³) by a distance d (cm), soft X-rays are absorbed by the obstacles, resulting in that the amount of post-transmitted soft X-rays I (μSv/h) is attenuated. Here, μ (cm²/g) represents the mass absorption coefficient.

FIG. 3A represents comparison among polyvinyl chloride (PVC), polycarbonate (PC), and polyethylene terephthalate (PET), with the vertical axis and the horizontal axis serving as a distance d and a soft X-ray shielding ratio, respectively,. The comparison of PVC, PC, and PET turns out that PVC can shield soft X-rays with a distance d one-digit shorter than those of the others. It is clear from this result that 1/E cm or about 4 mm is a sufficient thickness of PVC for totally shielding soft X-rays. As against this, PC and PET require about 2.8 mm to accomplish the same purpose.

FIG. 3B represents comparison among PVC, PC, and PET, with the left vertical axis and the right vertical axis serving as the mass absorption coefficient μ and the shielding ratio for soft X-rays, respectively. It is clear from the graphical representation that PVC has the highest mass absorption coefficient μ and shielding ratio of all, and further that the higher the mass absorption coefficient μ, the higher the shielding ratio.

In view of the above equation, therefore, it may be said from the fact that the larger the distance d, the higher the mass absorption coefficient μ, and further that the higher the atomic density ρ, the higher the mass absorption coefficient μ. Support for the above can be found from the reason that PVC contains chlorine having high atomic density not contained in PC and PET, resulting in that PVC has high shielding property. It is therefore possible to make the thickness of polyvinyl chloride small (i.e., to reduce the diameter of polyvinyl chloride) by the use of polyvinyl chloride made of a substance having high atomic density. Thereby, the housing 10, the accommodation body 20, the spherical members 21 as well as the below-described spacers 27 and column members 42 can be reduced in size. In addition, since polyvinyl chloride is an inexpensive material which is easily processable, the manufacturing cost can be suppressed. Note that examples of substances having high atomic density include boron nitride, silicone carbide, or the like.

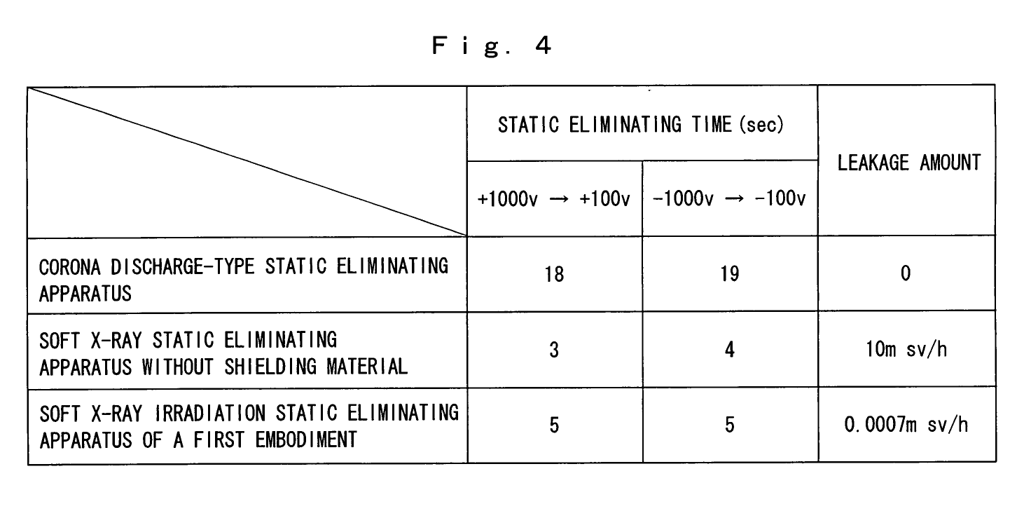

With the above apparatus configuration, comparative experiments on a static eliminating performance and a leakage amount of soft X-rays are conducted, and the results thereof are shown in FIG. 4. A corona discharge-type static eliminating apparatus, a soft X-ray irradiation static eliminating apparatus without shielding material, and the soft X-ray irradiation static eliminating apparatus 1 to which is applied the soft X-ray shielding unit 4 of the first embodiment are used for comparison. Note that, according to the corona discharge-type static eliminating apparatus, a high voltage is applied to the electrode with an acute tip so as to generate corona discharge and ionize air, and then the ionized air is supplied to a charged body 26 (see FIG. 1) for static elimination.

As to the static eliminating performance, time to eliminate static up to +100 V is measured by blowing ionized air into the charged material 26 charged to +1000 V at a position 60 cm away therefrom, and time to eliminate static from −1000 V to −100 V is measured in the same manner. As to the leakage amount of soft X-rays, on the other hand, it is measured with a survey meter at a position 60 cm away from the charged body 26. As a result of the measurements, it is found that the time to eliminate static with the soft X-ray irradiation static eliminating apparatus 1 of the present embodiment is about one-fourth less than that required by the corona discharge-type static eliminating apparatus and is approximately the same as that required by the soft X-ray irradiation static eliminating apparatus without shielding material. Besides, it has turned out that the leakage amount of soft X-rays according to the soft X-ray irradiation static eliminating apparatus without shielding material is 10 mSv/h, while that according to the soft X-ray irradiation static eliminating apparatus 1 of the present embodiment becomes endlessly close to zero. Accordingly, it can be said that soft X-rays are almost totally shielded without deteriorating the static eliminating performance of the soft X-ray irradiation static eliminating apparatus without shielding material.

As described above, since it is so designed that soft X-rays are shielded by the plurality of vinyl balls according to the shielding unit 4 of the first embodiment, it is possible to totally shield soft X-rays and smoothly supply ionized air. Accordingly, the shielding unit 4 can be securely used even in the presence of a man without deteriorating its static eliminating performance. Besides, the use of a substance having high atomic density makes it possible to reduce the apparatus configuration in size and offer more convenience to the user. Note that, although the fan unit 2, the soft X-ray irradiating unit 3, and the shielding unit 4 are separately formed in the present embodiment, the apparatus may be configured in such a manner that the soft X-ray irradiating unit 3 and the fan unit 2 are integrally formed (case-integrated), or the soft X-ray irradiating unit 3 and the shielding unit 4 are integrally formed (case-integrated). Alternatively, the fan unit 2, the soft X-ray irradiating unit 3, and the shielding unit 4 may be integrally formed (case-integrated). The structure can thus be simplified. Although spherical shielding materials are used in the present embodiment, polyhedral shielding materials may also be used.

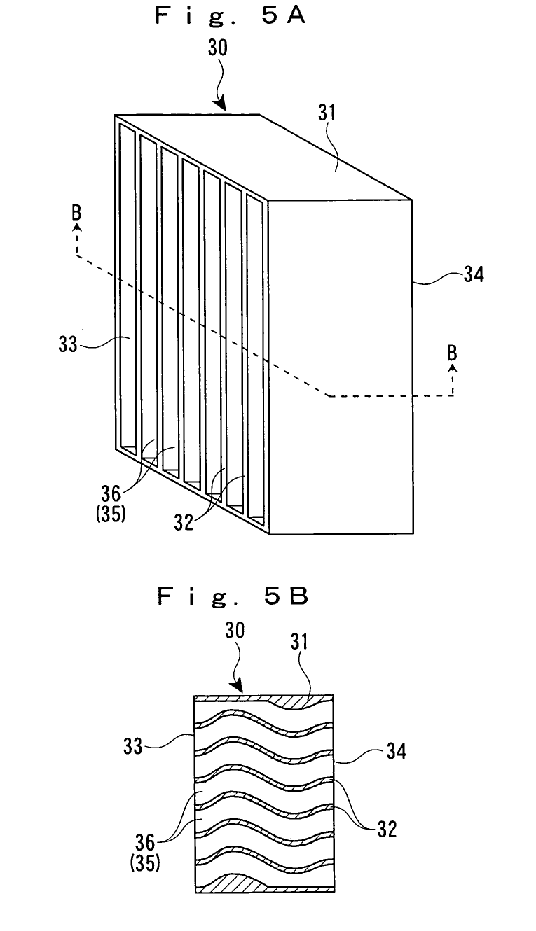

Referring next to FIGS. 5A and 5B, description will be made about a shielding unit 30 according to a second embodiment. The shielding unit 30 of the present embodiment includes an accommodation body 31 made of polyvinyl chloride and a plurality of spacers 32 integrally formed therewith. The accommodation body 31 has a box-shaped structure as in the case of the first embodiment and is provided with an inflow opening 33 at its rear surface and an outflow opening 34 at its front surface (see FIG. 5A). The plurality of spacers 32 are disposed parallel to one another so as to partition an air passage 35 of the accommodation body 31 running from the inflow opening 33 to the outflow opening 34 (see FIG. 5B). Accordingly, a plurality of air passage segments 36 running from the inflow opening 33 to the outflow opening 34 are formed, and the inflow opening 33 and the outflow opening 34 are slit-shaped to correspond to them. Besides, the plurality of spacers 32 are undulately formed toward an air flowing direction 17, and the air passage segments 36 partitioned into a plurality of passages undulately extend among them. In this case, the plurality of air passage segments 36 are undulately formed so as not to allow a straight traveling of soft X-rays. Therefore, when soft X-rays attempt to travel to the outflow opening 34, they will hit on the spacers 32 and be absorbed therein. On the other hand, ionized air passes through the air passage segments 36 between the respective spacers 32 and moves toward the outflow opening 34.

As described above, according to the second embodiment, since soft X-rays are shielded by the plurality of spacers 32, it is possible to totally shield soft X-rays and smoothly supply ionized air. Besides, since the accommodation body 31 and the plurality of spacers 32 are integrally formed, the shielding unit can be easily manufactured.

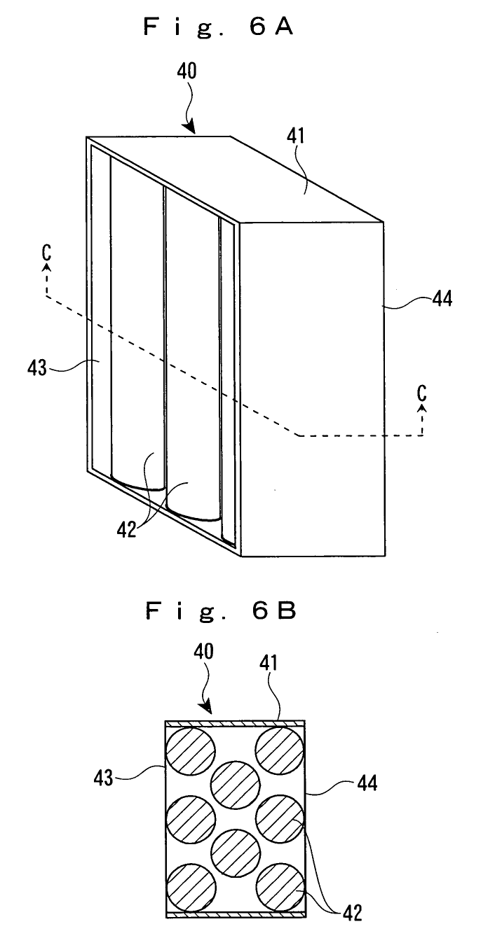

Referring to FIGS. 6A and 6B, description will be made about a shielding unit 40 according to a third embodiment. The shielding unit 40 of the present embodiment includes an accommodation body 41 made of polyvinyl chloride and a plurality of column members 42. The description of the accommodation body 41 will be omitted since the configuration thereof is the same as that of the second embodiment. A plurality of column members 42 extend in the direction orthogonal to an air passage 35 (see FIG. 6A). The plurality of column members 42 are disposed in a staggered manner in the extending direction, and the respective column members have interspace among them (see FIG. 6B). Note that, since the plurality of column members 42 are disposed in such a manner as not to allow a straight traveling of soft X-rays through gaps, the soft X-rays are prevented from passing through the shielding unit 40. Accordingly, the soft X-rays will hit on the plurality of column members 42 and be absorbed therein. On the other hand, the ionized air moves from an inflow opening 43 to an outflow opening 44 through the gaps.

As described above, according to the third embodiment, since soft X-rays are shielded by the plurality of column members 42, it is possible to totally shield the soft X-rays and smoothly supply ionized air. Besides, since the accommodation body 41 and the plurality of column members 42 are integrally formed, the shielding unit can easily be manufactured.

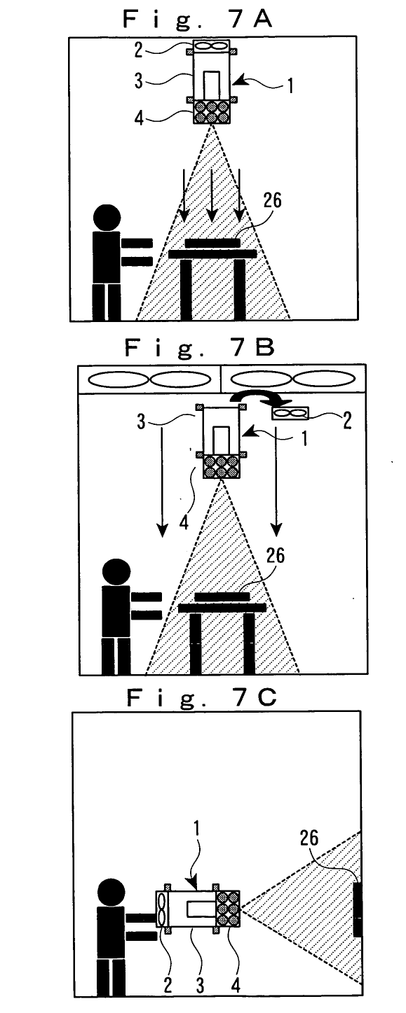

Referring now to FIGS. 7A to 7C, description will be made about examples of using the soft X-ray irradiation static eliminating apparatus 1 of the present embodiment. As described above, according to the soft X-ray irradiation static eliminating apparatus 1, the fan unit 2 and the shielding unit 4 are detachably attached to the soft X-ray irradiating unit 3. In FIG. 7A, the soft X-ray irradiation static eliminating apparatus 1 is installed on, for example, the ceiling in an upright position and the fan unit 2 is attached thereto. Ionized air is supplied therefrom to the charged body 26 located below. At this time, even if the charged body 26 lies in the environment having no air flow, enough air flow to efficiently eliminate the static of the charged body 26 can be obtained. In FIG. 7B, the soft X-ray irradiation static eliminating apparatus 1 is installed in an upright position and the fan unit 2 is detached therefrom. The soft X-ray irradiation static eliminating apparatus 1 is disposed such that the air from the ceiling is supplied to the introduction port 11 of the soft X-ray irradiating unit 3. Air can be then supplied from the soft X-ray irradiation static eliminating apparatus 1 to the charged body 26, thereby making it possible to sufficiently eliminate the static of the charge body 26. In FIG. 7C, the soft X-ray irradiation static eliminating apparatus 1 is turned sideways and held by a man. At this time, the air from the soft X-ray irradiation static eliminating apparatus 1, in which the respective units are integrated, can be supplied to the desired charged body 26. Accordingly, the soft X-ray irradiation static eliminating apparatus 1 can be selectively used, either by attaching or detaching the respective units, to suit the situations such as a case in which the fan unit 2 is required when the apparatus is used alone or that in which the fan unit 2 is not required when air flow is ensured.

What is claimed is:

1. A soft X-ray shielding structure of a soft X-ray irradiation static eliminating apparatus which irradiates air to be supplied with soft X-rays and ionizes the same, the soft X-ray shielding structure allowing the passing of the ionized air and shielding the soft X-rays and comprising:
an accommodation body having a mesh-like inflow opening and a mesh-like outflow opening and made of a soft X-ray shielding material; and
a plurality of massive members filled in the accommodation body and made of a substance shielding electromagnetic waves.

2. The soft X-ray shielding structure according to claim 1, wherein
each of the massive members is formed into a spherical shape.

3. The soft X-ray shielding structure according to claim 1, wherein
each of the massive members is made of a substance having high atomic density.

4. The soft X-ray shielding structure according to claim 1, wherein
each of the massive members is made of polyvinyl chloride.

5. A soft X-ray shielding structure of a soft X-ray irradiation static eliminating apparatus which irradiates air to be supplied with soft X-rays and ionizes the same, the soft X-ray shielding structure allowing the passing of the ionized air and shielding the soft X-rays and comprising:
an accommodation body having an inflow opening and an outflow opening and made of a soft X-ray shielding material; and
a plurality of spacers for partitioning an air passage running from the inflow opening to the outflow opening into a plurality of passages and made of a substance shielding electromagnetic waves, wherein the plurality of spacers are disposed parallel to one another and undulately extend from the inflow opening to the outflow opening.

6. A soft X-ray shielding structure of a soft X-ray irradiation static eliminating apparatus which irradiates air to be supplied with soft X-rays and ionizes the same, the soft X-ray shielding structure allowing the passing of the ionized air and shielding the soft X-rays and comprising:
an accommodation body having an inflow opening and an outflow opening and made of a soft X-ray shielding material; and
a plurality of column members crossing an air passage running from the inflow opening to the outflow opening and made of a substance shielding electromagnetic waves, wherein
the plurality of column members are disposed parallel to one another along the air passage in a staggered manner.

7. A soft X-ray irradiation static eliminating apparatus comprising:
the soft X-ray shielding structure according to claim 1;
a housing having an introduction port into which air is introduced and an emission port from which the air is emitted; and
a soft X-ray irradiating unit which is provided in the housing and irradiates the air flowing in the housing with X-rays, wherein
the emission port is connected directly with the inflow opening.

8. The soft X-ray irradiation static eliminating apparatus according to claim 7, wherein
a peripheral wall portion of the accommodation body is integrally formed with that of the housing.

9. The soft X-ray irradiation static eliminating apparatus according to claim 7, wherein
the soft X-rays irradiated by the soft X-ray irradiating unit are oriented in the same direction as the flowing direction of the air.

10. The soft X-ray irradiation static eliminating apparatus according to claim 7, wherein
a fan for supplying the air is detachably attached on the side of the introduction port of the housing.

11. The soft X-ray irradiation static eliminating apparatus according to claim 7, wherein
a fan for supplying the air is provided in the housing facing the introduction port.

12. An ionized-air emitting method of a soft X-ray irradiation static eliminating apparatus which irradiates air to be supplied with soft X-rays and emits the same after being ionized, the method comprising:
having the ionized air passed through the deposition of a plurality of massive members made of a substance shielding electromagnetic waves and emitted therefrom.
